(19) United States
(12) Patent Application Publication
(10) Pub. No.: US 2015/0327727 A1
(43) Pub. Date: Nov. 19, 2015

(54) STAINLESS STEEL THERMAL INSULATION DRINKING BEVERAGE CONTAINER AND MANUFACTURING METHOD THEREOF

(71) Applicant: TONY WU, Taipei City (TW)

(72) Inventor: TONY WU, Taipei City (TW)

(21) Appl. No.: 14/280,561

(22) Filed: May 16, 2014

(51) Int. Cl. A47J 41/02; B05D 1/02; B05D 3/00; B05D 3/12; B05D 3/02

(52) U.S. Cl. CPC A47J 41/028; B05D 3/12; B05D 3/0254; B05D 3/002; B05D 1/02

(57) ABSTRACT

The present invention relates to a stainless steel thermal insulation drinking beverage container and a manufacturing method thereof, particularly with regard to a stainless steel thermal insulation drinking beverage container which can reduce unpleasant odor therein and is convenient to clean up. The container is made through manufacturing steps of preparing and providing a bottle body, vacuuming, surface treatment, spray coating, baking and drying, and high temperature sintering, and so on. A ceramic layer is formed on an inner wall face of the stainless steel bottle body with a vacuum mezzanine. Accordingly, the ceramic layer is used for blocking direct contact between drinking beverages and the stainless steel bottle body in order to reduce occurrence of unpleasant odor in drinking beverages and to enhance convenience of cleaning up.

### BACKGROUND OF THE INVENTION

1. Field of the Invention

The present invention relates to a technical field of a drinking beverage container, particularly with regard to a stainless steel thermal insulation drinking beverage container able to reduce occurrence of unpleasant odor in filled drinking beverages in the container and to enhance convenience and cleanness of cleaning up.

2. The Related Arts

Usually, water plays an important role in aspect of human health. Many studies have suggested having appropriate water intakes. In recent years under requirements of drinking hygiene and environmental protection, more and more people carry drinking container with them for personal handy drinking when they go out. In addition, under requirements of health preservation and maintenance of flavors, drinking containers with thermal insulation effect is further developed, and such kind of thermal insulation drinking water containers is mainly stainless steel bottles or jars.

However, when people use the aforementioned stainless steel thermal insulation drinking water container to fill and load drinking water (such as hot water, hot coffee, hot tea, hot ginseng tea, and so on), hot drinking water with high temperatures is easy to react with stainless steel inner walls and occur unpleasant odor in the drinking water. As a result, such odor not only causes drinkers to worry about hygiene issues, but also destroys the flavor of the drinking water. In addition, after long-termed use of the inner wall of the stainless steel thermal insulation drinking water container, its metal surface is prone to generation of attachments. Addition to wear of the inner wall due to brushing and washing, the container becomes difficult to be effectively cleaned and cleanliness of the interior of the stainless steel thermal insulation drinking water container is highly affected.

In other words, the existing drinking container has common problem of being prone to have unpleasant odor and inconvenience of cleaning up, and so on, and is unable to satisfy requirements of actual use due to influence of its imperfect design. Hence, how to solve the existing problem is an important issue in the industry.

Accordingly, the named inventors have researched further on the aforementioned problem in use of existing drinking containers, and actively seek a solution through many years of research and manufacturing experience during working in the related industry. After continuous efforts to research and test, a stainless steel thermal insulation drinking beverage container and a manufacturing method thereof is finally successfully developed in order to overcome regret of using the existing drinking container.

### SUMMARY OF THE INVENTION

Therefore, the main objective of the present invention is to provide a stainless steel thermal insulation drinking beverage container able to reduce occurrence of unpleasant odor in filled drinking beverages in the container, and to enhance convenience and cleanness of cleaning up for improving its utility and usefulness.

In addition, another main objective of the present invention is to provide a manufacturing method of the stainless steel thermal insulation drinking beverage container. By the method, a ceramic layer is formed on an inner wall face of the stainless steel thermal insulation drinking beverage container comprising a vacuum mezzanine. Through characteristics of high density and smoothness of ceramic, occurrence of unpleasant odor in drinking beverages is reduced and a manufacturing yield of the container is raised.

The present invention is primarily through the following technical means to physically realize the aforementioned objectives and effectiveness. The container comprises a bottle body made of stainless steel, and the bottle body comprises a chamber with an upward opening. Furthermore, a vacuum mezzanine is formed between inner and outer walls of the bottle body.

The chamber of the bottle body comprises an inner wall face, and a surface of the inner wall face comprises a smooth ceramic layer.

The manufacturing method of the stainless steel thermal insulation drinking beverage container comprises the following.

A. In a first step of preparing and providing a bottle body, a bottle body with a chamber is made and produced in use of processing technology to form an interval mezzanine between the inner and outer walls of the bottle body.

B. In a second step of vacuuming, air in the interval mezzanine is entirely extracted out of the interval mezzanine between the inner and outer walls of the bottle body in use of vacuuming technology, and the mezzanine is sealed to form a vacuum mezzanine at peripheral sides and a bottom side of the bottle body.

C. In a third step of surface treatment, an inner wall face of the chamber of the bottle body is roughened in use of surface treatment technology.

D. In a fourth step of spray coating, a ceramic layer is spray coated on the inner wall face of the chamber of the bottle body.

E. In a fifth step of baking and drying, the ceramic layer is baked and dried in use of baking and drying technology in order to make the ceramic layer dried enough for adhesion on the inner wall face of the chamber of the bottle body.

F. In a sixth step of high temperature sintering, the ceramic layer is high-temperature sintered in use of high-temperature sintering technology in order that the ceramic layer is completely adhered and attached to the inner wall face of the chamber, and forms a ceramic smooth surface for completion of the bottle body of the stainless steel thermal insulation drinking beverage container.

Therefore, through physically realizing the above mentioned technical means, when the bottle body of the stainless steel thermal insulation drinking beverage container of the present invention is used to load and fill with drinking beverages, the filled drinking beverages is hardly reacted with the ceramic layer after the high-temperature drink beverages contact with the ceramic layer since the inner wall face of the bottle body is equipped with the ceramic layer. As a result, phenomenon of odor occurring of the filled drinking beverages is able to be reduced to ensure safety of drinking beverages and to avoid destroying of flavors of drinking beverages. Moreover, after long-termed use of the inner wall equipped with the ceramic layer of the bottle body, cleanness of the chamber of the bottle body is capable of being effectively maintained and the bottle body can be conveniently cleaned by users because the ceramic layer is not easily adhered, attached and worn by foreign matters. As a result, the stainless steel thermal insulation drinking beverage container of the present invention is much more improved than the existing products in effective aspects of “odor reducing”, “convenience of cleaning”, “enhancing cleanness”, etc.

In order for further understanding to constitutions, features and other purposes of the present invention, preferred embodiments of the present invention is recited and depicted accompanying with the drawings described in detail as follows in order to allow those who are familiar with the technical field able to implement the present invention in accordance with the following specification.

### BRIEF DESCRIPTION OF THE DRAWINGS

FIG. 1 shows a schematic partial cross-sectional side view of a stainless steel thermal insulation drinking beverage container in accordance with the present invention; and

FIG. 2 shows a schematic flow diagram of a manufacturing method of the stainless steel thermal insulation drinking beverage container in accordance with the present invention.

### DETAILED DESCRIPTION OF PREFERRED EMBODIMENT

The present invention relates to a stainless steel thermal insulation drinking beverage container and a manufacturing method thereof. The physical embodiments of the present invention and components thereof illustrated together with accompanying drawings are described for convenience only to specify everything with regarding to front and rear, left and right, top and bottom, upside and downside, and horizontal and vertical references, etc. Such descriptions are not to limit the present invention, nor to limit any illustrated component of the present invention to any position or spatial orientation. Within the inventive spirit of the present invention and the scope as defined in the following claims, the sizes specified in the drawings and specification can make all sorts of changes based on designs and requirements of physical embodiments of the present invention.

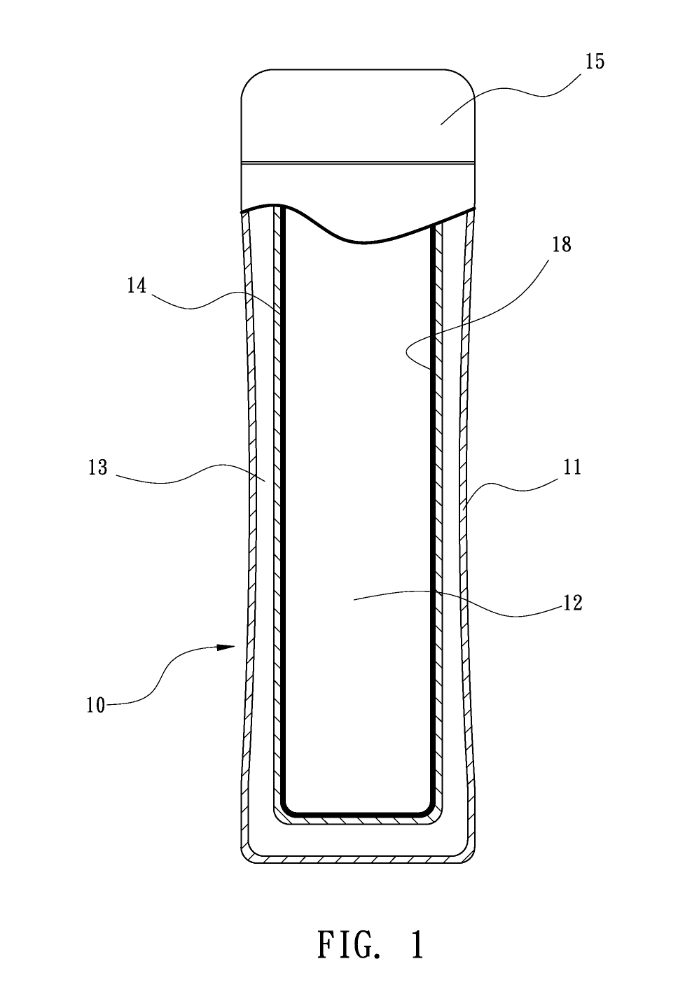

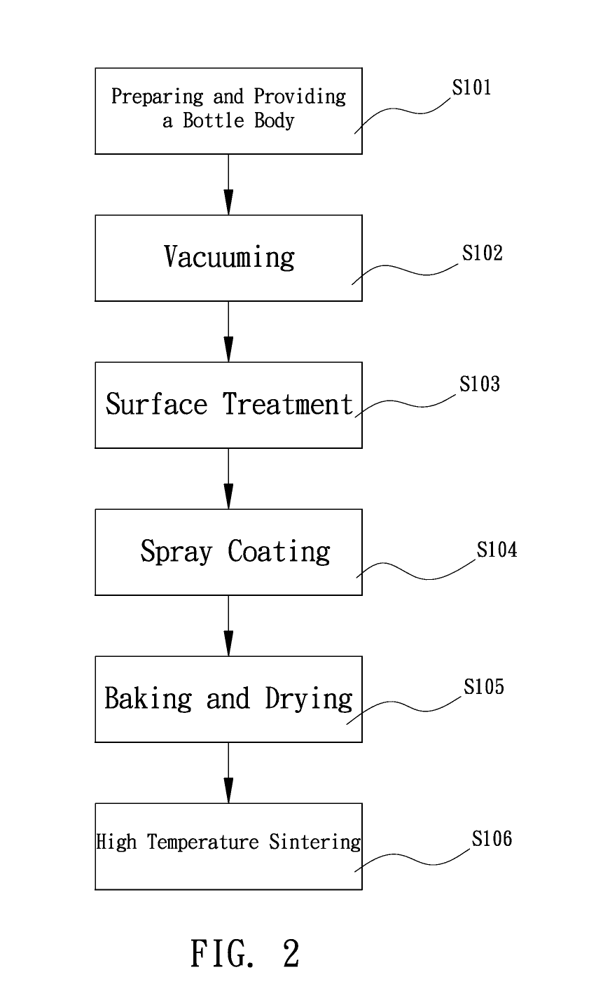

The detailed configuration of a stainless steel thermal insulation drinking beverage container of the present invention is as shown in FIGS. 1 to 2. The stainless steel thermal insulation drinking beverage container 10 comprises a bottle body 11, and the bottle body 11 (or named as “jar body”) is made of stainless steel. The bottle body 11 comprises a chamber 12 with an upward opening. Furthermore, a vacuum mezzanine 13 is formed between inner and outer walls of the bottle body 11, and a bottle top 15 is further formed at a top of the bottle body 11 to optionally close the opening of the chamber 12. The present invention is characterized that the chamber 12 of the bottle body 11 comprises an inner wall face 14, and a surface of the inner wall face 14 comprises a smooth ceramic layer 18. In use of characteristics of the ceramic layer 18 including high density and smoothness, unpleasant odor of drinking beverages occurred due to reactions in drinking beverage can be reduced, and adherence of foreign matters in the drinking beverages is further reduced to improve cleanliness of the drinking beverages and to provide convenience of cleaning. The stainless steel thermal insulation drinking beverage container 10 is made by manufacturing steps comprising a first step S101 of preparing and providing the bottle body 11, a second step S102 of vacuuming, a third step S103 of surface treatment, a fourth step S104 of spray coating, a fifth step S105 of baking and drying and a sixth step S106 of high temperature sintering, etc.

In proceeding the first step S101 of preparing and providing the bottle body 11, the bottle body 11 with the chamber 12 is made and produced by a typical processing technology to form the interval mezzanine 13 between the inner and outer walls of the bottle body 11.

In processing the second step S102 of vacuuming after the bottle body 11 is made and produced, air in the interval mezzanine 13 between the inner and outer walls of the bottle body 11 is entirely extracted out of the interval mezzanine 13 in use of vacuuming technology, and then the vacuumed mezzanine 13 is sealed. As a result, the vacuum mezzanine 13 can be formed at peripheral sides and a bottom side of the bottle body 11 for blocking heat transmission between an inside and an outside of the bottle body 11 in order to equip the inner chamber 12 of the bottle body 11 with thermal insulation function.

In processing the third step S103 of surface treatment after the vacuum mezzanine 13 of the bottle body 11 is made and produced, the inner wall face 14 of the chamber 12 of the bottle body 11 is surface-treated in use of typical surface treatment technology, for example, sandblasting. Roughness of the inner wall face 14 of the chamber 12 can be enhanced in order to improve an adhesion effect thereof.

In processing the fourth step S104 of spraying coating after completion of surface treatment on the inner wall face 14 of the chamber 12 of the bottle body 11, the bottle body 11 is heated to 40° C. to 50° C. and the ceramic layer 18 is sprayed and covered on the inner wall face 14 of the chamber 12.

Moreover, in processing the fifth step S105 of baking and drying after the ceramic layer 18 is spraying coated, the ceramic layer 18 is baked and dried in use of typical baking and drying technology at a temperature of 140 to 160° C. in a drying time of 30 to 40 minutes in order to make the ceramic layer 18 dried enough for adhesion.

Finally, in processing the sixth step S106 of high temperature sintering after the bottle body 11 is baked and dried, the ceramic layer 18 is high temperature sintered at a temperature of 260° C. to 280° C. in a sintering time of 10 to 20 minutes in order that the ceramic layer 18 is completely adhered and attached to the inner wall face 14 of the chamber 12 and forms a ceramic smooth surface for completion of manufacturing of the bottle body 11 of the stainless steel thermal insulation drinking beverage container 10 of the present invention.

Through the above mentioned structural design in actual use of the stainless steel thermal insulation drinking beverage container 10 of the present invention, when people use the bottle body 11 of the stainless steel thermal insulation drinking beverage container 10 to load and fill with drinking beverages (such as hot water, hot coffee, hot tea, hot ginseng tea, and so on), the filled drinking beverages is hardly reacted with the ceramic layer 18 after the high-temperature drink beverages contact with the ceramic layer 18 since the inner wall face 14 of the chamber 12 of the bottle body 11 is equipped with the ceramic layer 18 and the ceramic layer 18 has characteristics of high density and fair smoothness, etc. As a result, phenomenon of odor occurring of the filled drinking beverages is able to be reduced to ensure safety of drinking beverages and to avoid destroying of flavors of drinking beverages.

Moreover, after long-termed use of the inner wall equipped with the ceramic layer 18 of the stainless steel thermal insulation drinking beverage container 10, cleanness of the chamber 12 of the bottle body 11 is capable of being effectively maintained because the ceramic layer 18 is not easily adhered and attached by foreign matters. As a result, the bottle body 11 can be conveniently cleaned by users to further enhance the cleanness of the interior of the chamber 12 of the bottle body 11 so as to further increase add-on values of products and enhance economic efficiency thereof.

In summary, it is understood that the present invention is a new type of invention with excellent creative ideas. The present invention not only effectively solves problems faced by those skilled in the art, but also enhances effectiveness thereof significantly. Besides, no identical or similar product inventions able to enhance effectiveness thereof are seen or in public use in the same technical field. It is understood that the present invention may be embodied in other forms within the scope of the claims. Thus the present examples and embodiments are to be considered in all respects as illustrative, and not restrictive, of the invention defined by the claims.

What is claimed is:

1. A stainless steel thermal insulation drinking beverage container, comprising a bottle body made of stainless steel, and the bottle body further comprising a chamber with an upward opening, a vacuum mezzanine formed between inner and outer walls of the bottle body; wherein
the chamber of the bottle body comprises an inner wall face, and a ceramic layer is formed on a surface of the inner wall face.

2. The stainless steel thermal insulation drinking beverage container as claimed in claim 1, wherein a bottle top is formed at a top of the bottle body to optionally close the opening of the chamber.

3. A manufacturing method of a stainless steel thermal insulation drinking beverage container, comprising:
A. a first step of preparation and providing a bottle body, wherein the bottle body with a chamber is made and produced in use of processing technology to form an interval mezzanine between inner and outer walls of the bottle body;
B. a second step of vacuuming, wherein air in the interval mezzanine is entirely extracted out of the interval mezzanine between the inner and outer walls of the bottle body in use of vacuuming technology, and the mezzanine is sealed to form a vacuum mezzanine at peripheral sides and a bottom side of the bottle body;
C. a third step of surface treatment, wherein an inner wall face of the chamber of the bottle body is roughened in use of surface treatment technology;
D. a fourth step of spray coating, wherein a ceramic layer is spray coated on the inner wall face of the chamber of the bottle body;
E. a fifth step of baking and drying, wherein the ceramic layer is baked and dried in use of baking and drying technology in order to make the ceramic layer dried enough for adhesion on the inner wall face of the chamber of the bottle body; and
F. a sixth step of high temperature sintering, wherein the ceramic layer is high-temperature sintered in use of high-temperature sintering technology in order that the ceramic layer is completely adhered and attached to the inner wall face of the chamber, and forms a ceramic smooth surface for completion of the bottle body of the stainless steel thermal insulation drinking beverage container.

4. The manufacturing method of the stainless steel thermal insulation drinking beverage container as claimed in claim 3, wherein in the third step of surface treatment, the inner wall face of the chamber of the bottle body is roughened in use of sandblasting technology.

5. The manufacturing method of the stainless steel thermal insulation drinking beverage container as claimed in claim 3, wherein in the fourth step of spray coating, the bottle body is heated to 40° C. to 50° C. for spray coating of the ceramic layer.

6. The manufacturing method of the stainless steel thermal insulation drinking beverage container as claimed in claim 3, wherein in the fifth step of baking and drying, the ceramic layer is baked and dried at a temperature of 140° C. to 160° C. in a drying time of 30 to 40 minutes.

7. The manufacturing method of the stainless steel thermal insulation drinking beverage container as claimed in claim 3, wherein in the sixth step of high temperature sintering, the ceramic layer is high-temperature sintered at a temperature of 260° C. to 280° C. in a high-temperature sintering time of 10 to 20 minutes.
